(19) United States
(12) Patent Application Publication
(10) Pub. No.: US 2005/0144640 A1
(43) Pub. Date: Jun. 30, 2005

(54) Method and system for recording scheduled programs with an optional backup copy stored in a centrally located storage server farm

(75) Inventors: Jean-Georges Fritsch, Los Altos Hills, CA (US); Nam Phu Thanh Do, Pleasanton, CA (US)

Correspondence Address: ROGER H. CHU, 19499 ERIC DRIVE, SARATOGA, CA, 95070, US

(73) Assignee: Minerva Networks, Inc., Santa Clara, CA (US)

(21) Appl. No.: 11/066,985

(22) Filed: Feb. 25, 2005

Related U.S. Application Data
(63) Continuation-in-part of application No. 10/899,712, filed on Jul. 26, 2004.
Application No. 10/899,712 is a continuation of application No. 09/595,848, filed on Jun. 16, 2000, now Pat. No. 6,769,127.

(51) Int. Cl. H04N 7/173; G06F 13/00; H04N 5/445; G06F 3/00

(52) U.S. Cl. 725/58; 725/94; 725/95; 725/89

(57) ABSTRACT

Improved techniques to record one or more scheduled programs for later viewing are disclosed. Without compromising the quality of a broadcast program being currently delivered in a required bandwidth of a network, a buffer mechanism is provided to accommodate using of the remaining available bandwidth of the network to deliver the requested one or more scheduled programs. In one embodiment, the buffer mechanism is controlled or configured to convert transmission rates of the scheduled programs to be recorded in accordance with the remaining available bandwidth. Thus the required bandwidth needed to ensure the quality of the scheduled program being currently delivered for viewing is not affected. The buffered contents are transmitted to the client machines via a broadband local loop using uni-cast, multi-cast or a combination of both. An optional backup copy of the locally recorded scheduled programs is stored in a centrally located storage server farm.

### CROSS-REFERENCE TO RELATED APPLICATION

This application is a continuation-in-part of U.S. patent application Ser. No.: 10/899,712 filed on Jul. 26, 2004, which is a continuation of U.S. patent application Ser. No.: 09/595,848, filed on Jun. 16, 2000, now U.S. Pat. No.: 6,769,127. The contents of these prior related applications are hereby incorporated by reference in their entirety for all purposes.

### BACKGROUND OF THE INVENTION

1. Field of the Invention

The present invention is generally related to media broadcasting and, more particularly, to multimedia delivery methods and systems for facilitating recording scheduled broadcast programs as requested by subscribers or users.

2. Description of the Related Art

The Internet is a rapidly growing communication network of interconnected computers around the world and is penetrating into every household in the United States and many other countries in the world. Together, these millions of connected computers form a vast repository of multimedia information that is readily accessible by users through any of the connected computers from anywhere at anytime. Multimedia information that is commonly available and deliverable via the Internet may include text information, images and graphics, video and audio, and alike.

Continuous media information such as video and audio contents has become one of the most demanded resources over the Internet. Delivery of such information over the Internet provides many advantages and benefits that cannot be matched by current terrestrial (over-the-air), cable or satellite television systems. Given the vast accessibility of the Internet to the general population, many Internet service providers or Internet content providers are starting to broadcast continuous media programs over the Internet.

Like the traditional broadcasting scheme through the terrestrial, cable or satellite systems, continuous media programs can also be scheduled for broadcasting over the Internet. An often happened problem for user to view these programs is that the scheduled broadcast is not convenient. For example, a particular program is scheduled to broadcast in the morning, but a user wishes to watch in the evening. In another example, a particular program of interest to the user is scheduled to broadcast, when a user has to take care of an unexpected task or errand.

Video Cassette Recorders (VCRs) were introduced many years ago to accommodate the need of users to record scheduled programs for later viewing. Although the VCR allows programs to be recorded, the VCR is inconvenient in various ways. Namely, the recording of a program requires that sufficient VCR tape capacity be provided. Often one sacrifices the recording quality to lengthen the effective tape capacity (e.g., extending a 2-hour tape to a 4- or 6-hour tape). Likewise, the playback of a recorded program on a VCR tape often requires the user to locate the start of the program on the VCR tape. This is a tedious, time consuming task when the program does not start at the beginning of the VCR tape. Also, to later view the program, the user must be in possession of not only the VCR tape having the program recorded thereon but also a VCR nearby.

To avoid inherent problems of VCR described above, one solution is based on Personal Video Recorder (PVR) introduced by TiVo Inc. (see www.tivo.com) allows for recording of scheduled programs in a local storage device (e.g., hard disk) that connects to set-top box. FIG. 1A shows a configuration 100 of the PVR model. On the user (i.e., subscriber, client) side, there is typically a set-top box 102 coupled to a recording mechanism 104. The set-top box 102 can be programmed to record scheduled programs delivered from a media server or server 106. The delivery center 106 is configured to feed one or more scheduled programs from a source 108 to its subscribers or users. Depending on settings with the set-top box 102, a user may record one scheduled program on one channel of the recording mechanism 104 while viewing another broadcast program on another channel. The bandwidth for recording a broadcast program in good quality is typically 6 megabits per second (Mbits/sec) that is currently beyond most of the networks available to residential homes. As a result, either the program being recorded in the recording mechanism 104 or both programs being recorded and viewed is delivered in less desirable quality, so that the delivery of both programs can be accommodated with the bandwidth of the network. In addition the quality problem, there are financial concerns with PVR. The earlier described scenario of viewing and recording two different scheduled programs simultaneously requires either two single circuitry set-top boxes or two sets of circuitry in one set-top box. Further, if a user wishes to record third or fourth programs, it will require user to purchase and install additional set-top boxes or a set-top box with higher number of circuitry.

Another scheme for flexibly viewing scheduled programs without the inherent problem of VCR is to record the scheduled programs in a storage device that is centrally located (e.g., a video server) instead of distributed in PVR. FIG. 1B shows the configuration 150 for the video server scheme, which essentially moves the recording mechanism 104 of FIG. 1A to a remote location. As shown in FIG. 1B, the set-top box 102 on the user side is no longer coupled to the recording mechanism 104. Instead, the recording mechanism 104 is now coupled to a server 106 that diverts programs requested for recording to the recording mechanism 104, while the program for current viewing by a user is diverted to the set-top box 102. Because the two programs, one being recorded and the other being viewed are not sharing the same bandwidth of a network, the delivery of high quality of the broadcasts may be readily achieved. There is no extra set-top boxes requirement at the user side. However, the burden of recording and storing various requested programs is shifted to a service provider or the server 106. This solution is not scalable at all. As the media service provider gets more subscribers (i.e., users), the infrastructure such as the server 106 has to increase its capacity in portion of the number of users.

Therefore, there is a need for improved techniques for recording one or more scheduled programs without affecting the video quality and at the same time without increasing operation burdens on a user or on a service provider.

### SUMMARY OF THE INVENTION

Broadly speaking, the invention relates to techniques for recording one ore more scheduled programs for later retrieval (e.g., viewing or listening). According to one aspect of the invention, a system and method are provided to record one or more scheduled programs without impacting the quality of a scheduled program currently being viewed or listened to by a subscriber (i.e., a currently broadcast program). To facilitate the discussion of the present invention, the use of “view” or “viewing” herein indicates that a scheduled program can be viewed or listened to, or simply enjoyed by a subscriber or a user. The scheduled programs to be recorded are those that are to be or being broadcasted.

In another aspect of the invention, for ensuring the quality of a currently broadcast program, a particular amount of the network bandwidth (i.e., required minimum bandwidth or broadcast bandwidth) must be reserved and used for transporting the playing program via a local loop network (e.g., xDSL). When the same subscriber/user requests one or more other scheduled programs to be recorded in a local user storage device via the same local loop network during the same time, the quality of the currently broadcast program can only be maintained if the simultaneous recording does not use more than the remaining bandwidth of the data network. If remaining bandwidth of the local loop is not large enough to accommodate these requested simultaneous recording when delivering in broadcast bandwidth, a buffer mechanism controlled by a server is provided to hold all or some of the requested recording (i.e., buffered contents). These buffered contents will be delivered to the user based on a number of schemes such as uni-cast, multi-cast, or a combination of both, utilizing the remaining bandwidth of the local loop network in the most efficient way. Because the remaining bandwidth may become larger, for example, user has just finished viewing the currently broadcast program, the delivery of the buffered contents is adjusted to a higher speed accordingly. In one embodiment, the buffer mechanism is controlled or configured to convert transmission rates of the scheduled programs to be recorded in accordance with the remaining available bandwidth. Without affecting the required bandwidth needed to ensure the quality of the scheduled program being delivered, the buffer mechanism is configured to best use the remaining available bandwidth of the network. In another embodiment, the determination of using uni-cast or multi-cast depends upon a number of factors including, but not limited to, server resources, remaining bandwidth of the local loop network, the number of requests for a particular buffered contents, etc.

The invention can be implemented in numerous ways, including a method, system, device, or a computer readable medium. Several embodiments of the invention are discussed below.

As a method for recording of scheduled programs, the method comprises determining whether there is a broadcast being currently delivered for viewing by a subscriber, when a request is received to record one or more of scheduled programs;

when the subscriber is not viewing the broadcast,
delivering the one or more of the scheduled programs over a network at a transmission speed not exceeding a bandwidth of the network;

when the subscriber is viewing the broadcast,
determining a remaining bandwidth of a network that is allocated for transmitting the broadcast;
buffering the one or more of the scheduled programs so that the one or more of the scheduled programs are delivered at a transmission speed not exceeding the remaining bandwidth of the network.

As a system for recording one or more of scheduled programs, the system comprising a server configured to deliver the scheduled programs to a plurality of subscribers, the server configured to determine whether there is a broadcast being currently delivered for viewing by a subscriber, when a request is received to record one or more of the scheduled programs;

when the subscriber is not viewing the broadcast,
the server delivering the one or more of the scheduled programs over a network at a transmission speed not exceeding a bandwidth of the network;

when the subscriber is viewing the broadcast,
the server determining a remaining bandwidth of a network that is allocated for transmitting the broadcast;

a buffer, coupled to the server, buffering the one or more of the scheduled programs so that the one or more of the scheduled programs are delivered at a transmission speed not exceeding the remaining bandwidth of the network.

The advantages of the invention are numerous. Different embodiments or implementations may yield one or more of the following advantages. One advantage of the invention is that scheduled programs can be recorded locally when a user is viewing another program. The scheduled programs requested for recording, for example, in a local recording device, can be done controllably at the same time while the currently broadcast program is being delivered. Another advantage is that the scheduled programs for requested recording are delivered in the most efficient way via uni-cast, multi-cast, or a combination of both, to optimize the usage of the available server resource and of the remaining bandwidth in the delivery network.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A shows a configuration of the PVR model;

FIG. 1B shows another approach that essentially moves the recording mechanism of FIG. 1A to a centrally controlled remote location;

FIG. 2A illustrates a media delivery system according to one embodiment of the invention;

FIG. 2B is a block diagram of a data delivery system according to one embodiment of the invention;

FIG. 2C illustrates a configuration of delivering three scheduled programs with a buffer mechanism in accordance with one embodiment of the invention;

FIG. 2D shows a flow diagram or process of delivering multiple channels to a client machine in accordance with one embodiment of the present invention;

FIG. 3 is a block diagram of a media server according to one embodiment of the invention;

FIG. 4 is a flow diagram of client recording request process according to one embodiment of the invention; and

FIGS. 5A and 5B are representative screen shots for communicating a recording request from a client machine according to one embodiment of the invention.

### DETAILED DESCRIPTION OF THE INVENTION

The invention relates to improved techniques for recording one or more scheduled programs for later retrieval (e.g., viewing or listening). According to one aspect of the invention, a system and method are provided to record one or more scheduled programs without impacting the quality of a scheduled program currently being viewed or listened to by a subscriber. To facilitate the discussion of the present invention, the use of “view” or “viewing” herein indicates that a broadcasting program can be viewed or listened to, or simply enjoyed by a subscriber or a user. The scheduled programs to be recorded are those that are to be or being broadcasted. Other aspects and advantages of the invention will become apparent from the following detailed description taken in conjunction with the accompanying drawings which illustrate, by way of example, the principles of the invention.

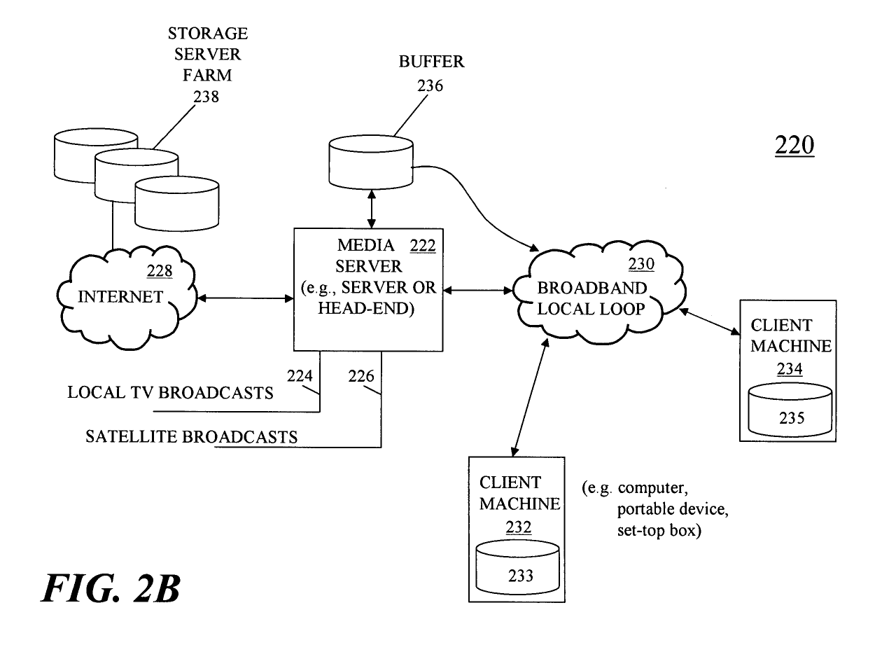

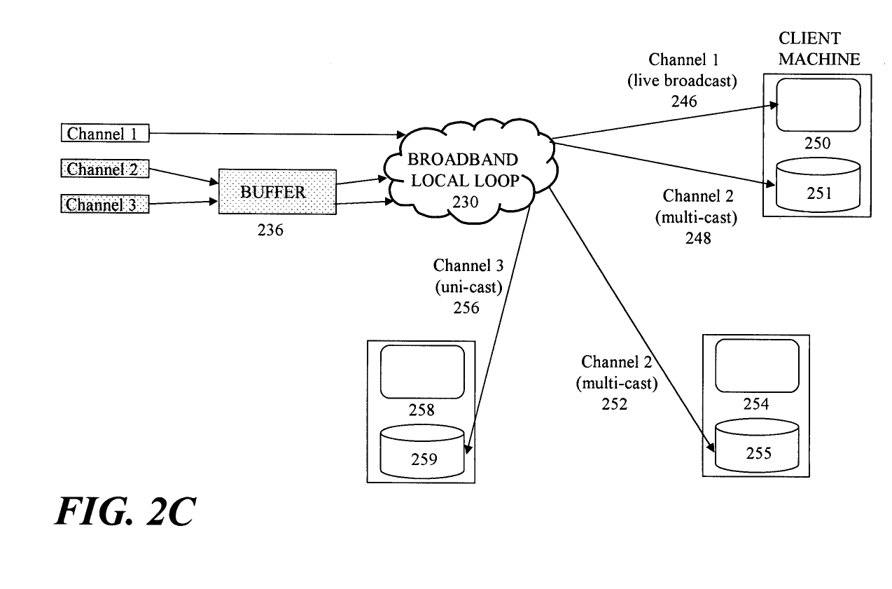

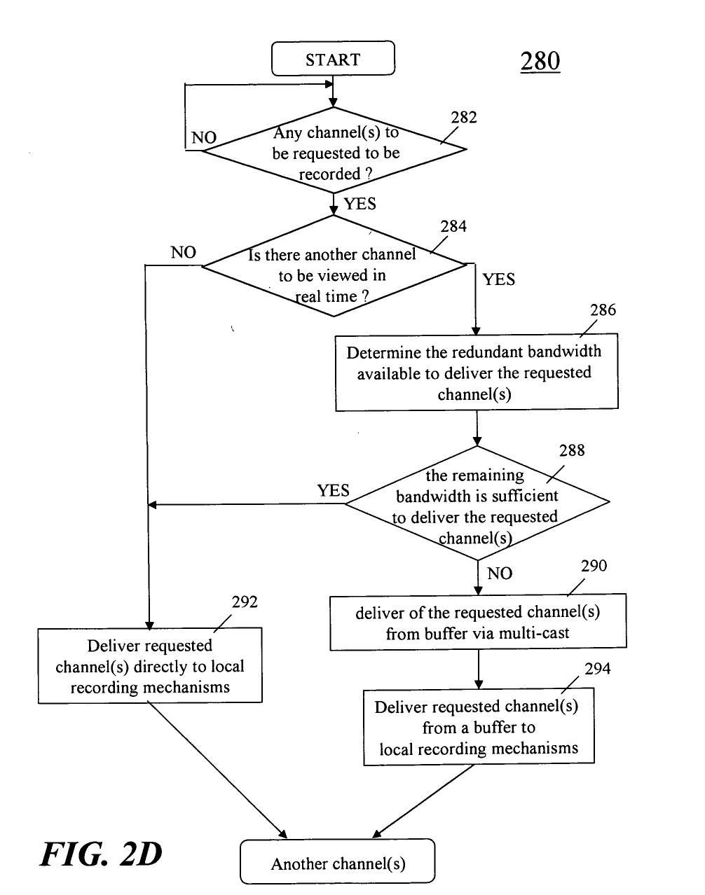

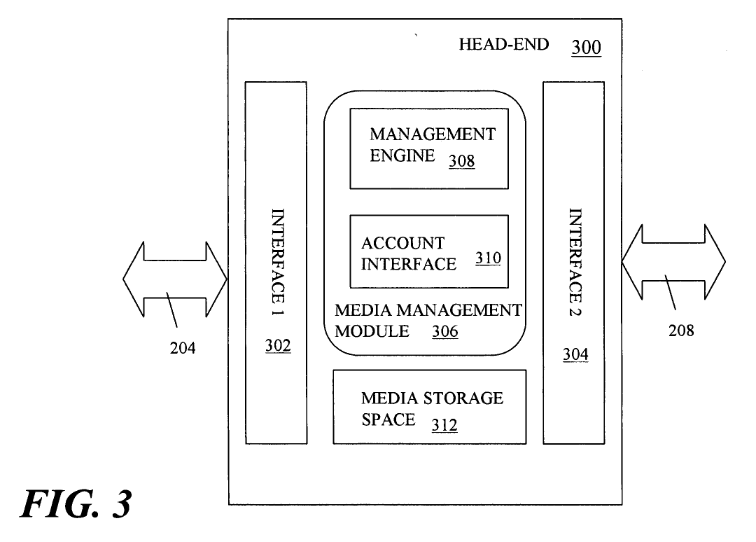

Embodiments of this aspect of the invention are discussed below with reference to FIGS. 2A-5B. However, those skilled in the art will readily appreciate that the detailed description given herein with respect to these figures is for explanatory purposes as the invention extends beyond these limited embodiments.

FIG. 2A illustrates a media delivery system 200 according to one embodiment of the invention. The media contents are provided by one or more media sources (i.e., content providers) 202. Examples of media sources include broadcast television stations, satellite receivers, television relay stations, analog or digital radio station and Internet sites that provide continuous media signals over the Internet. The media contents can take a variety of forms including, but not limited to, movies (videos), audio, news, games, commercial advertisement, events, etc. The media delivery system 200 comprises one or more servers 206, of which only one is shown in FIG. 2A. The servers 206 can also be referred to as head-ends. Each of the servers 206 can provide continuous media services, video-on-demand services and audio-on-demand services to its subscribers. Each of the servers 206 can also provide video/audio mail services and commercial information delivery to its subscribers.

To facilitate the description of the invention, it is assumed below that the media source 202 delivers video contents including scheduled or non-scheduled programs and the server 206 is configured to provide video services to its subscribers or users. As noted above, it should be recognized that the media source 202 is not limited to delivering or supplying video programs. Those skilled in the art will understand that the description herein can be equally applied to other continuous media forms, such as audio programs delivered over a data network.

The server 206 communicates with the media source 202 through a delivery agent 204. Depending on implementation, the delivery agent 204 can, for example, represent a receiver, a data network, a transcoder (encoder and decoder), or a converter. When the media source 202 is a satellite dish, a broadcasting or relay station, then the delivery agent 204 includes a receiver which receives television (TV) signals that are often in a form that may need to be processed by a transcoder (i.e., encoder and decoder). Generally, such TV signals are in an analog format. Hence, the delivery agent 204 can include an encoder that digitizes the TV signals and converts the digitized TV signals to a digital format (e.g., MPEG) so that the signals can be further processed, stored, and redelivered over a network 208. In one embodiment, the delivery agent 204 includes a commercially available transcoder, Minerva VNP™, provided from Minerva Networks, Inc., having a business address of 2111 Tasman Drive, Santa Clara, Calif. 95054.

On the other hand, when the media source 202 is a network video source over a data network (e.g., the Internet), the delivery agent 204 may be simply part of the data network or may include a converter. Typically, a video source provided by a service or content provider is in MPEG format and may/may not required conversion depending on the version of the MPEG format. As described above, the media source 202 may take one of the many available video sources and supply it to the server 206 in an appropriate format via the delivery agent 204. In the following description, unless otherwise specifically required, the server 206 receives one or more appropriate video sources, typically in MPEG format, from the media source 202 via the delivery agent 204.

The network 208 couples the server 206 to a terminal device 210. The network 208 can be part of a larger network including the Internet, the public switch telephone network (PSTN), a private network, or a wireless network. Through the network 208, the terminal device 210 can receive video services provided by the server 206. Examples of the terminal device 210 may include a desktop computer, a laptop or notebook computer, a set-top box, and a mobile device. In one embodiment, the terminal device 210 (utilized by one or more users) can be coupled to the network 208 by way of a circuit-switched or packet-switched connection. The network 208 can use one or more different transmission mediums, such as a telephone network, a broadband network (e.g., xDSL, ATM or SONET), etc. It is, however, useful that the transmission mediums have high bandwidths to support delivery of media-rich content and to ensure the quality of service (QoS) thereof.

FIG. 2B is a block diagram of a data delivery system 220 according to one embodiment of the invention. The data delivery system 220 can represent one embodiment of the media delivery system 200 illustrated in FIG. 2A. The data delivery system 220 includes a video delivery center 222 that controls the delivery of video content. The video delivery center 222 receives media-rich broadcasts, such as television or video, from various sources. As shown in FIG. 2B, the video delivery center 222 receives local TV broadcasts 224 and satellite broadcasts 226. In addition, the video delivery center 222 can couple to the Internet 228 and thereby also receive Internet broadcasts at the video delivery center 222. The video delivery center 222 operates to receive the different types of analog and digital broadcasts and to formulate them into digital content data encapsulated in IP (Internet Protocol) data packets that are subsequently delivered as scheduled programs to a number of clients/subscribers/users.

To distribute the scheduled programs from the video delivery system 222 to client machines 232 and 234, the video delivery center 222 couples through a broadband local loop 230. Although only two client machines 232 and 234 are shown in FIG. 2B, the video delivery center 222 can support many client machines. Examples of client machines include personal computers, portable computers, Personal Digital Assistants (PDAs), set-top boxes, hand-held computers, etc. In one embodiment, the video delivery center 222 is provided in a local region and is thus able to couple to the broadband local loop 230 which has access to the client machines 232 and 234. The broadband local loop 230 offers broadband network access between the video delivery center 222 and the client machines 232 and 234. For example, the broadband local loop 230 can use one or more of xDSL, ATM, SONET, fiber optic lines, a private/public telephone network, or CAT-5.

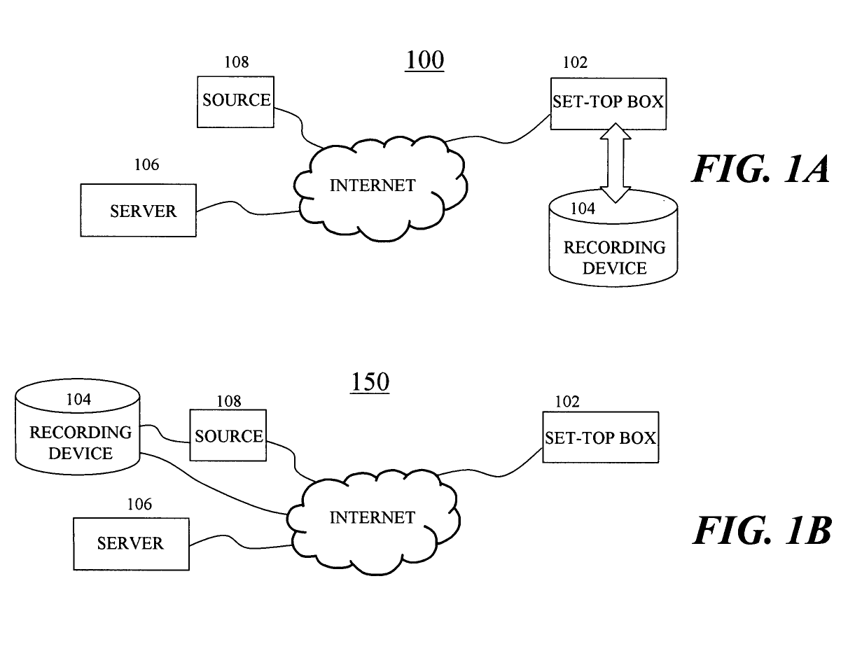

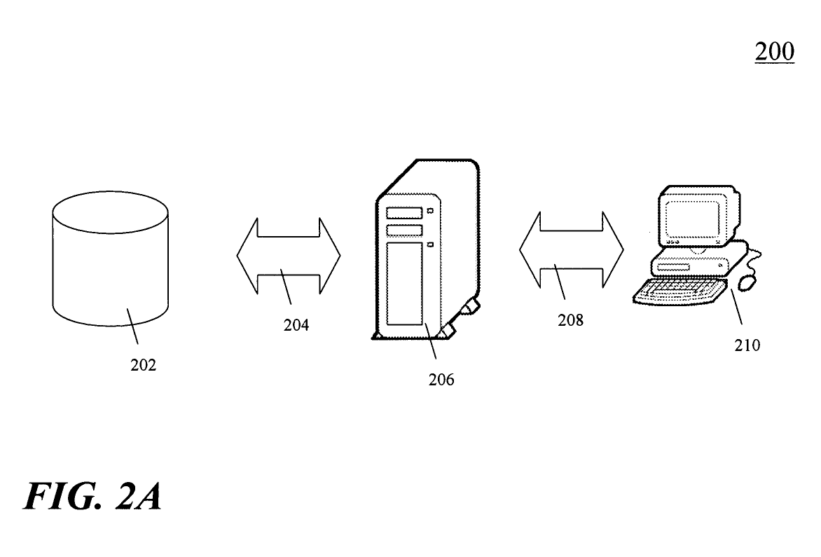

Different from the configurations in FIG. 1A and FIG. 1B, the video delivery center 222 is coupled to a buffering mechanism or buffer 236. By definition and as used herein, a buffer is a data area shared by more than one device or process that operates at different speeds or with different sets of priorities. The buffer allows each device or process to operate without being held up by the other. In order for a buffer to be effective, one aspect of the present invention is to provide means for moving data into and out of the buffer in conjunction with a recording mechanism 233 or 235 in or coupled to the client device 232 or 234 and the transmission medium therebetween. Acting like a cache, the buffer 236 is a “midpoint holding place” and configured to support the coordination of various different activities.

According to one embodiment of the present invention, the buffer 236 is configured to buffer one or more scheduled programs (broadcasting or streaming) to the recording mechanism 233 without compromising the video quality of another program being viewed in the same time. In other words, given a bandwidth of a network, the buffer 236 is configured to deliver one or more scheduled programs at a variable transmission rate to the recording mechanism 233 via a broadband local loop 230. For example, assume that the bandwidth of a network (e.g., the local loop 230) is W, while the bandwidth required to deliver a currently broadcast program in certain desirable quality from a media delivery server (e.g., the server 222) to a client machine 232 is Q, and it is assumed that W is greater than Q. According to one aspect of the present invention, the bandwidth difference, or remaining bandwidth, or bandwidth redundancy, W-Q, can be used for delivery of other scheduled programs (i.e., buffered contents hereinafter) from the buffer 236 to the recording mechanism 233. Depending on the number of these other scheduled programs is requested to be recorded in the recording mechanism 233, the delivery speed of these other scheduled programs varies and is limited to the remaining bandwidth (W-Q) in order not to affect the required bandwidth Q to maintain the certain desired quality of the currently broadcast program. To accomplish this goal, the buffered contents may be delivered to the client recording mechanism 233 in a number of ways: uni-cast, multi-cast, or a combination of both. In one embodiment, the discovery of whether a subscriber/user/client is watching a broadcast program is based on the standby mode of the set-top box. When a user puts the set-top box in the standby mode, the program module on the video delivery center detects this signal and thus allows the free-up bandwidth to be used for delivery of other buffered contents. In another embodiment, a special purpose circuitry is included in a set-top box to detect whether a television display is on or off. When the television display is off, the bandwidth of the broadband local loop may be used for delivering buffered contents.

Also shown in FIG. 2B is a storage server farm 238 coupling to the Internet 228. According to one embodiment, the storage server farm 238 is provided to hold the backup copy of the recorded programs in the local storage space associated with the local recording mechanisms 233 and 235. When a user/subscriber/client has a concern about loosing the recorded programs in the local storage, the user may have option to push the recorded programs to such storage server farm 238 owned by a service provider.

FIG. 2C illustrates a configuration of delivering three scheduled programs being broadcasted in channels 1, 2 and 3 simultaneously in accordance with one embodiment of the invention. In this embodiment, channel 1 is watched on a display of client machine 250, while channels 2 and 3 are requested to be recorded by subscribers/users at client machines 250, 254 and 258. As shown in FIG. 2C, channel 1 is delivered to the client machine 250 at a speed (i.e., a first speed) guaranteeing the required quality of the currently broadcast program for viewing on the display of the client system 250, while channels 2 and 3 are delivered through the buffer 236, then at another speed (i.e., a second speed) to the recording mechanisms 251, 255 and 259, in the client machines 250, 254 and 258, respectively. The contents of channels 2 and 3 are referred to as the buffered contents hereinafter. The network for delivery of the contents of these channels is a broadband local loop 230, which may include, but not be limited to, xDSL, ATM, SONET, fiber optic lines. The total bandwidth of the broadband local loop is W. The first speed is Q. The second speed can not exceed W-Q, otherwise, the quality of the currently broadcast program will suffer. In general, the first speed Q takes a large portion of the total bandwidth W. So, when the client system is receiving a currently broadcast program, the second speed is typically slower than the first speed. However, when the client machine is idle (i.e., the first speed is equal to zero) or the total bandwidth W is so large that the remaining bandwidth W-Q is larger than Q, it is possible to deliver the buffered contents to a client in a speed equal to or faster than the minimum required bandwidth for a live broadcast Q. The scheme to deliver buffered contents faster than the minimum required bandwidth may include, but not be limited to, a more efficient compression algorithm, different packet size, etc.

By virtual of the present invention, the buffer 236 is provided to buffer the scheduled programs broadcast in channels 2 and 3. The buffer 236 does not store the contents in channel 2 and channel 3, instead the buffer 236 is provided to facilitate the best use of the available remaining bandwidth in the local loop 230 between the buffer 236 and client machines 250, 254 or 258. The buffer 236 is intelligently controlled to deliver the buffered contents for channel 2 and/or channel 3 to the recording mechanisms 251, 255, and 259 in a most efficient scheme such as uni-cast, multi-cast or a combination of both. In order to utilize the available remaining bandwidth in the local loop in a most efficient manner, the detection of available bandwidth is vital. According to one embodiment, as soon as the set-top box is set to the standby mode, the bandwidth for the currently broadcast program becomes available for delivery of the buffered contents. In another embodiment, a special purpose circuitry is included in a set-top box for detecting whether the television display is on or off regardless of the set-top box is in standby mode or not. As soon as the circuitry detects the television display is turned off, the bandwidth will become available. Also the delivery of the buffered contents does not affect the quality of any currently broadcast program at the client machines. In one embodiment, the buffer 236 is configured to perform a rate conversation process to ensure the delivery of the buffered contents would not affect the currently play program. For example, as shown in FIG. 2C, the delivery 248 of buffered contents for channel 2 to client recording mechanism 251 uses a remaining bandwidth W-Q, because the bandwidth Q is being used to live broadcast 246 the contents of channel 1. In a second embodiment, the buffered contents of channel 3 are delivered to client recording mechanism 259 via a uni-cast 256 likely with a speed higher than the minimum required speed, because the client machine 258 is idle. For example, the delivery of the buffered contents at late night can take advantage of many idling client systems. In a third embodiment, the buffered contents of channel 2 are delivered to two client recording mechanisms 251 and 255 via multi-cast 248 and 252. In another embodiment, a compression process is applied when the contents go through the buffer 236, in which case, a de-compression process is applied in the recording mechanism 251.

The present invention is not limited to the configuration shown in FIG. 2C, which includes only three channels of scheduled programs and three client machines. The spirit of the invention described in FIG. 2C still applies to a configuration with hundreds of channels and thousands of clients. The buffer mechanism is provided to ensure that the recording of scheduled program can be managed with the flexibility, efficiency, effectiveness, scalability inherited in the present invention.

FIG. 2D shows a flow diagram or process 280 of delivering scheduled programs in multiple channels to a client machine in accordance with one embodiment of the present invention. The process 280 may be implemented in software, hardware or a combination of both. According to one embodiment, the process 280 is implemented in a server configured to deliver one or more scheduled programs to a plurality of subscribers or users.

When a user determines to record one or more of the scheduled programs in the local recording device, a recording request is sent from over a network to the server. The recording request may include an identifier identifying account associated with the user, an address identifying a client machine associated with the user and information about the scheduled programs (i.e., channel, program title, start time, end time, etc.).

At 282, when the recording request is received at the server for one or more scheduled programs in one or more channels, the process 280 moves on to a test 284. At 284, the process 280 determines the bandwidth status of the delivering network (e.g., broadband local loop 230 in FIG. 2B between server and client). The delivery of these request programs in multiple channels will occur, if the bandwidth is large enough to accommodate the transmission, and if the server has enough resource. However, in most cases, the bandwidth of the delivery network is limited. The delivery of these programs most likely depends on whether the user is not viewing another program when the delivery of request scheduled programs occurs. If the user is not viewing any program or the client machine is idle, thus leaving sufficient bandwidth to deliver these schedules program directly to the recording device coupled to or in the client machine. In this case, the process 280 follows the no branch to 292, where the requested scheduled programs are delivered directly to the recording device.

On the other hand, if the user is viewing another broadcast program in a channel, the available bandwidth for the delivery network is reduced to the remaining bandwidth so that the quality of the currently broadcast program will not suffer. In this case, the process 280 moves to 286, where the remaining bandwidth is calculated. Then the process moves to 288 to determine if the remaining bandwidth is sufficient to deliver the requested scheduled programs. In some installations, a network may provide sufficient bandwidth, or the remaining bandwidth is sufficient for delivering another one or two scheduled programs. In this case, the process 280 moves to 292 where the requested programs are delivered directly to the recording device.

Going back to test 288, when it is determined that the remaining bandwidth is not sufficient to deliver the requested programs, the process 280 moves to 290. A buffer (e.g., 236 of FIG. 2C) is activated to slow down the delivery of the requested broadcasts so as to not affect the delivery of the broadcast being currently watched by the user. Depending on implementation, the buffer may be configured to implement a rate conversation, a transcoding process or an encryption process. The rate conversation may be from a high data rate to a low data rate when the remaining bandwidth is not sufficient to accommodate the normal delivery of the requested broadcasts. The rate conversation may also be from a low data rate to a high data rate when the remaining bandwidth, typically the user is not watching a broadcast, is so sufficient to accommodate a higher speed than the normal delivery of the requested broadcasts requires. According to one embodiment, the buffer comprises a plurality of memory chips to a certain capacity. According to another embodiment, the buffer may include, but be limited to, hard disk storage, disk array, direct attached storage (DAS), network attached storage (NAS), storage area network (SAN), and alike. At 294, the requested programs are thus delivered via the buffer. The programs that are buffered are referred to as the buffered contents.

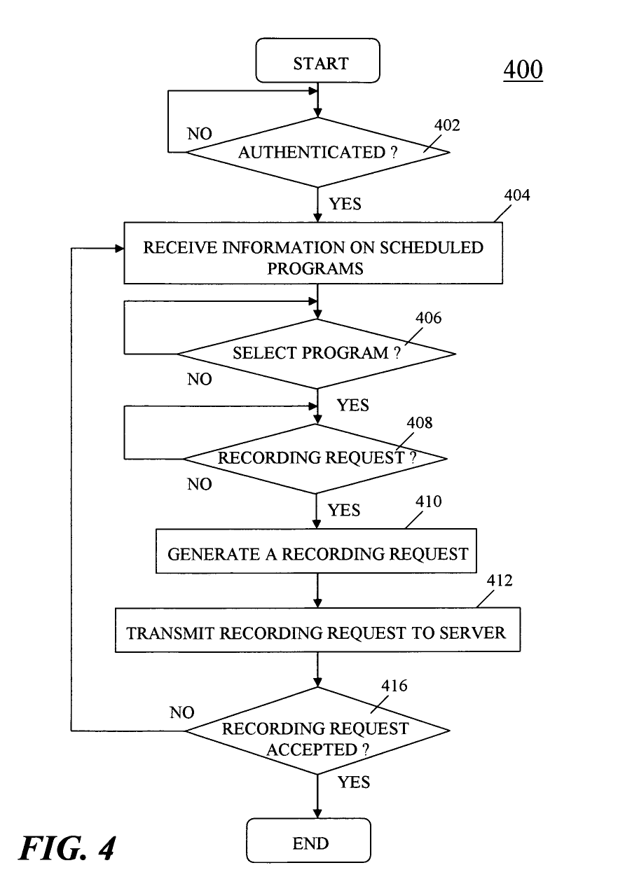

The delivery of the buffered contents from the server to the client may be done via uni-cast, multi-cast or a combination of both. In the first embodiment, uni-cast is chosen in order to maximize the speed of the delivery. For example, there is a plurality of recording requests for a number of different programs. Each of the requests can be delivered via uni-cast with different bit rate to optimize the speed. This scenario is most likely to implement when most of the client systems are idle such as late night with a relative large server infrastructure. In the second embodiment, multi-cast is chosen in order to minimize the server infrastructure. For example, there is a plurality of recording requests for a particular program. The buffered contents can be delivered at a very low bit rate via multi-cast in the background. In the third embodiment, a hybrid scheme of the first and second embodiment is implemented in the media management module (e.g., 306 of FIG. 3) to manage the delivery of the buffered contents. For example, uni-cast is first used until the server resources are not available any more, then the rest of requests is delivered using lower bit rate multi-cast.

FIG. 3 is a block diagram of a server 300 according to one embodiment of the invention. The server or head-end 300 is, for example, suitable for use as the server 206 illustrated in FIG. 2A or the video delivery center 222 illustrated in FIG. 2B. The server 300 includes a pair of interfaces 302 and 304 as well as a media management module 306. The media management module 306 operates to perform delivery of various scheduled programs (broadcasts) to subscribers/users/clients, to determine network status, and to divert scheduled programs for the recording request to one or more buffers to accommodate efficient delivery by using of the available bandwidth of the respective networks to client machines associated with the users.

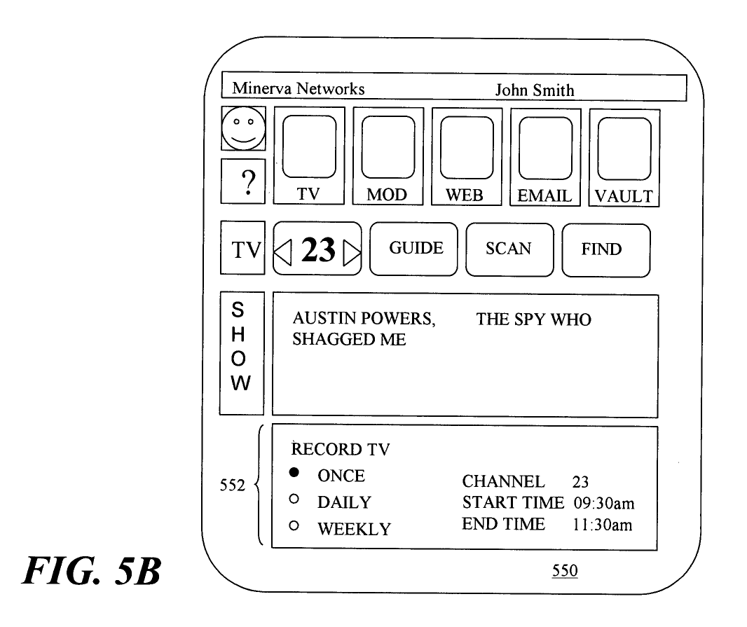

The media management module 306 includes a management engine 308 and an account interface 310. The management engine 308 provides a mechanism for managing accounts (e.g., account information) for subscribers that have subscribed to the media services provided by the server 300. An account can be provided and managed for each subscriber. Such accounts can be referred to as subscriber (or user) accounts. The accounts (account information) can be stored in the server 300 or in an external device accessible to the server 300. The account interface 310 is used to access the accounts. The server 300 also includes a media storage space 312 that serves to store various programs that are received at the interface 302 of the server 300. In one embodiment, the scheduled programs being received are cached in the media storage space 312 for a limited period of time. The media management module 306 operates to deliver (stream) the programs from the media storage space 312 to various clients over a network (e.g., network 208 in FIG. 2A or local loop 230 in FIG. 2B). The media storage space 312 may also store certain scheduled programs for longer durations, when subscribers have requested that the certain scheduled programs be recorded. Additional details on the operation of the server 300 are described below with respect to FIGS. 5A and 5B.

In one embodiment, the account information may be used to restrict the services that are made available to subscribers. For example, a group of premier subscribers are only allowed to have certain features offered by the server 300 for a subscription fee. Hence, when a request (e.g., recording request) is received from a subscriber over the network (e.g., 208 in FIG. 2A), the management engine 308 can check the corresponding account status through the account interface 310 and then allow the media management module 306 to perform the request when the account status permits. A service agreement between subscribers and media server can restrict or limit certain access to features or services.

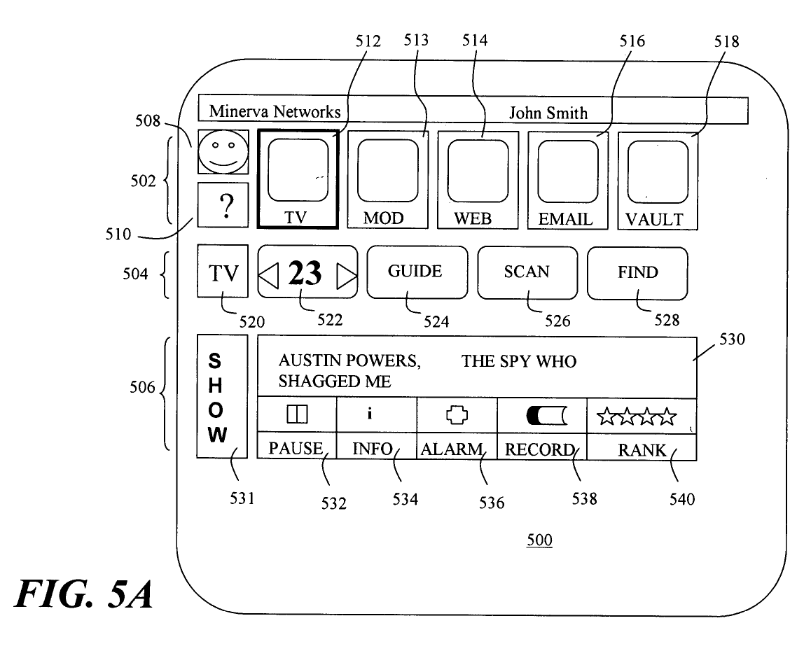

FIG. 4 is a flow diagram of client recording request process 400 according to one embodiment of the invention. The client record processing 400 is, for example, performed by a terminal device 210 illustrated in FIG. 2A or the client machines 262 or 264 illustrated in FIG. 2B.

The client recording request processing 400 begins with a decision 402 that determines whether the subscriber associated with the client device/machine is authenticated. When the decision 402 determines that the subscriber is not authenticated, the process 400 cannot be carried out until proper authentication is obtained. In one embodiment, the authentication is checked based on username and password which can be verified against information in the corresponding subscriber/user account information. In another embodiment, the authentication is carried out based on the installation of a set-top box in a residential address.

Once the decision 402 determines that proper authentication has been provided, the information of scheduled programs is received 404 and displayed as menu of choices on a display associated with the client device. In one embodiment, the received information of the scheduled program can include a list of titles with associated date, start time, duration, channel, and descriptions.

Next, a decision 406 determines whether a program selection has been made. Here, the subscriber at the client machine may select one of the scheduled programs from the menu or list received at 404. When the decision 406 determines that a program selection has not been made, the process 400 awaits such a selection. In this case, the subscriber can perform other actions, such as search or navigation actions, so as to display different information on the programs.

Once the decision 406 determines that a scheduled program has been selected, the process 400 moves to next decision 408. At 408, the process 400 determines whether a recording request has been made from the subscriber. In one embodiment, the record request is when a record button or icon in the menu on the display of the client device has been pressed or activated. When the decision 408 determines that a recording request has not yet been made, then the 400 awaits such a request. Once the decision 408 determines that a recording request has been made, then the recording request is transmitted 412 to the server. In one embodiment, the recording request identifies the selected program with associated channel, start time, and the subscriber information. In one embodiment, the request is transmitted over the Internet to the server using TCP/IP protocol.

Next, a decision 416 determines whether the record request has been accepted at the server. For example, the server might decline the record request when the subscriber does not have the service level for such service. In any case, when the decision 416 determines that the server has declined the record request, then the recording process 400 follows no branch to 404 for subsequent operations, such as additional recording requests may be processed, offering to sign up a service level that allows recording request just denied by the server, or notifying the subscriber the reason why the server has declined the request. On the other hand, when the decision 416 determines that the recording request has been accepted, then the process 400 is complete and ends. Alternatively, instead of ending, the process 400 may return to repeat the operation 404 for other recording requests.

The client recording request process 400 may be performed repeatedly for requesting either simultaneous or sequential recording of one or more scheduled programs. There is no restriction regarding channel, starting time or duration of each request. Another word, multiple programs or overlapped schedules are allowed in the process 400. For example, programs 1, 2 and 3 in channel A and programs 4, 5 and 6 in channel B are allowed to be requested for recording, and programs 2 and 5 will be broadcast simultaneously, thus be recorded at the same time. As a result, multiple programs from the same or different channels may be recorded as long as the service agreement permits. Also be noted that the process 400 is allows the recording request even if the scheduled programs are already in progress.

FIG. 5A is a representative screen shot 500 for a client device according to one embodiment of the invention. The screen shot 500 represents a Graphical User Interface (GUI) that appears on a display of a client device or machine. Generally, the GUI is provided by the media server and serves to provide an interface for a user/client/subscriber to communicate with the media server. According to one embodiment, the GUI is provided in a markup language and includes a number of active links (e.g., buttons or hyperlinks), each of the links can be activated to bring up another GUI (screen) for a different service. For TV services, the screen shot 500 includes a toolbar region 502, a program selection region 504, and an action region 506. In each of the toolbar region 502, the program selection region 504 and the action region 506, a number of buttons or icons (or controls) are included to provide user/client/subscriber to interact in the GUI. The toolbar region 502 includes a chat button 508 for initiating a chat session, a help button 510 for initiating a help screen, a television (TV) button 512 for initiating a TV program mode, a Media-On-Demand (MOD) button 513 for initiating a MOD mode, a web button 514 for initiating web access, an email button 516 for initiating an email program, and a vault button (e.g., a personal library) 518 for accessing recorded programs. The program selection region 504 includes a mode indicator section 520 for indicating mode (e.g., TV mode being selected in FIG. 5A), a channel selector 522 for selecting channels, a guide button 524 for access to a program guide, a scan button 526 for scanning through programs, and a find button 528 for searching for programs. The action region 506 includes a selected program display area 530 for identifying a selected program, and a show designator 531. In addition, the action region 506 includes a pause button 532 to pause a currently broadcast program, an information button 534 for obtaining information, an alarm button 536 for providing alarm information, a record button 538 for requesting a recording operation, and a rank button 540 for accessing, indicating or providing rank information of the program selected.

FIG. 5B illustrates a representative screen shot 550 for a client device associated with one embodiment of the invention. The screen shot 550 represents one of the GUIs that appears on a display of a client device and permits a subscriber to enter a recording request. Depending on implementation, a user may enter the recording request at a number of modes. For example, the recording request may be entered when the user is browsing a program guide or when the user is viewing a particular program. The screen shot 550 represents the screen shot 500 illustrated in FIG. 5A after the record button 538 has been pressed. After the record button 538 is activated, the display of the client device is updated, as shown by the screen shot 550, to include a recording information region 552. In this embodiment, the recording information region indicates that the selected program, namely, “Austin Powers, The Spy Who Shagged Me,” will be recorded from channel 23, beginning at the start time of 9:30 am, and ending at the end time of 11:30 am. And, in this embodiment, there are three recording choices: once (default), daily or weekly.

Once requested programs, items, or broadcasts have been recorded in the recording mechanism, the user can replay the recorded programs at any later time. If the recording mechanism is equipped with network capability, a user may access the recorded contents from anywhere in the network that the recording mechanism is connected. Typically, a menu or program guide is automatically generated in the recording mechanism to display a list or menu to show which programs have been recorded.

The invention is preferably implemented in software, but can be implemented in hardware or a combination of hardware and software. The invention can also be embodied as computer readable code on a computer readable medium. The computer readable medium is any data storage device that can store data which can be thereafter be read by a computer system. Examples of the computer readable medium include read-only memory, random-access memory, floppy disks, CD-ROMs, DVDs, magnetic tape, optical data storage devices, carrier waves. The computer readable media can also be distributed over network coupled computer systems so that the computer readable code is stored and executed in a distributed fashion.

The advantages of the invention are numerous. Different embodiments or implementations may yield one or more of the following advantages. Different embodiments or implementations may yield one or more of the following advantages. One advantage of the invention is that the scheduled programs can be recorded locally, while the user is viewing another broadcast program. Another advantage is that a buffer mechanism is provided to ensure the most efficient and effective delivery of the scheduled programs using the remaining bandwidth of the network, so that the quality of the broadcast program is not affected.

Many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. A method for recording one or more of scheduled programs, said method comprising:
determining whether there is a broadcast being currently delivered for viewing by a subscriber, when a request is received to record the one or more of the scheduled programs;
when the subscriber is not viewing the broadcast,
delivering the one or more of the scheduled programs over a network at a transmission speed not exceeding a bandwidth of the network;
when the subscriber is viewing the broadcast,
determining a remaining bandwidth of a network that is allocated for transmitting the broadcast;
buffering the one or more of the scheduled programs so that the one or more of the scheduled programs are delivered at a transmission speed not exceeding the remaining bandwidth of the network.

2. The method as recited in claim 1, wherein the request is generated from a client machine associated with the subscriber, the request including information identifying the subscriber, a recording mechanism, and the one or more of the scheduled programs.

3. The method as recited in claim 2, wherein the recording mechanism is in or coupled to the client machine, any contents in the recording mechanism can be replayed in the client machine.

4. The method as recited in claim 2, wherein the broadcast being currently delivered for viewing by the subscriber is delivered with desired quality at a transmission rate that takes most of the bandwidth of the network.

5. The method as recited in claim 4, wherein the remaining bandwidth is a portion of the bandwidth of the network that, if there is any, is not used without affecting desired quality of the broadcast being currently delivered for viewing by the subscriber.

6. The method as recited in claim 5, wherein the portion of the bandwidth is used to deliver the one or more of the scheduled programs via a buffer.

7. The method as recited in claim 6, wherein the buffer is remotely located with respect to the subscriber and configured to receive the one or more of the scheduled programs and to release the one or more of the scheduled programs at a reduced transmission speed so as not to exceed the portion of the bandwidth of the network.

8. The method as recited in claim 1, wherein the buffering of the one or more of the scheduled programs comprises:
receiving the one or more of the scheduled programs at a first data rate; and
releasing the one or more of the scheduled programs at a second data rate.

9. The method as recited in claim 8, wherein the buffering of the one or more of the scheduled programs is realized via a buffer comprising a plurality of memory arrays.

10. The method as recited in claim 9, wherein the buffer is configured to perform at least one of a rate conversation, a transcoding process or an encryption process.

11. The method as recited in claim 8, wherein the first data rate is faster than second data rate, if the subscriber is viewing the broadcast.

12. The method as recited in claim 8, wherein the second data rate is identical to or faster than the first data rate, if the subscriber is not viewing the broadcast.

13. The method as recited in claim 8, wherein releasing the one or more of the scheduled programs is via one of uni-cast and multi-cast.

14. The method as recited in claim 1, wherein the subscriber is not viewing the broadcast is determined, when a set-top box is put in standby mode or a special purpose circuitry in the set-top box detects television display is turned off.

15. The method as recited in claim 1, further comprising delivering the one or more scheduled programs to a storage server farm via the network as a backup copy.

16. A system for recording one or more of scheduled programs, the system comprising:
a server configured to deliver the scheduled programs to a plurality of subscribers, the server configured to determine whether there is a broadcast being currently delivered for viewing by a subscriber, when a request is received to record one or more of the scheduled programs;
when the subscriber is not viewing the broadcast,
the server delivering the one or more of the scheduled programs over a network at a transmission speed not exceeding a bandwidth of the network;
when the subscriber is viewing the broadcast,
the server determining a remaining bandwidth of a network that is allocated for transmitting the broadcast;
a buffer, coupled to the server, buffering the one or more of the scheduled programs so that the one or more of the scheduled programs are delivered at a transmission speed not exceeding the remaining bandwidth of the network.

17. The system as recited in claim 16, wherein the request is generated from a client machine associated with the subscriber, the request including information identifying the subscriber, a recording mechanism, and the one or more of the scheduled programs.

18. The system as recited in claim 17, wherein the recording mechanism is in or coupled to the client machine, any contents in the recording mechanism can be replayed in the client machine.

19. The system as recited in claim 17, wherein the broadcast being currently delivered for viewing by the subscriber is delivered with desired quality at a transmission rate that takes most of the bandwidth of the network.

20. The system as recited in claim 19, wherein the remaining bandwidth is a portion of the bandwidth of the network that, if there is any, is not used without affecting desired quality of the broadcast being currently delivered for viewing by the subscriber.

21. The system as recited in claim 20, wherein the portion of the bandwidth is used to deliver the one or more of the scheduled programs via the buffer.

22. The system as recited in claim 21, wherein the buffer is remotely located with respect to the subscriber and configured to receive the one or more of the scheduled programs and to release the one or more of the scheduled programs at a reduced transmission speed so as not to exceed the portion of the bandwidth of the network.

23. The system as recited in claim 16, wherein the buffering operates as follows:
receiving the one or more of the scheduled broadcasting programs at a first data rate; and
releasing the one or more of the scheduled broadcasting programs at a second data rate.

24. The system as recited in claim 23, wherein the buffer is configured to perform at least one of a rate conversation, a transcoding process or an encryption process.

25. The system as recited in claim 23, wherein the first data rate is faster than second data rate, if the subscriber is viewing the broadcast.

26. The system as recited in claim 23, wherein the second data rate is identical to or faster than the first data rate, if the subscriber is not viewing the broadcast.

27. The system as recited in claim 23, wherein releasing the one or more of the scheduled programs is via one of uni-cast and multi-cast.

28. The system as recited in claim 16, wherein the subscriber is not viewing the broadcast is determined, when a set-top box is put in standby mode or a special purpose circuitry in the set-top box detects television display is turned off.
